(19) United States
(12) Patent Application Publication
(10) Pub. No.: US 2020/0255658 A1
(43) Pub. Date: Aug. 13, 2020

(54) RESIN COMPOSITION, PRODUCTION METHOD OF THE SAME AND MOLDED PRODUCT

(71) Applicant: Konica Minolta, Inc., Tokyo (JP)

(72) Inventors: Kosuke NAKAMURA, Tokyo (JP); Masashi MAMINO, Tokyo (JP); Yo NAKAJIMA, Tokyo (JP)

(21) Appl. No.: 16/713,888

(22) Filed: Dec. 13, 2019

(30) Foreign Application Priority Data
Feb. 12, 2019 (JP) 2019-022342

(51) Int. Cl. C08L 69/00; C08J 3/20

(52) U.S. Cl. CPC C08L 69/00; C08L 2201/02; C08L 2205/06; C08J 3/203

(57) ABSTRACT

Provided is a resin composition containing a polycarbonate, a glass fiber, and an olefin-acrylate copolymer or an olefin-acrylic acid copolymer, wherein a mass ratio value (GF/OA) of a content of the glass fiber (GF) to a content of the olefin-acrylate copolymer or the olefin-acrylic acid copolymer (OA) is in the range of 1.0 to 6.0.

### CROSS-REFERENCE TO RELATED APPLICATION

The entire disclosure of Japanese Patent Application No. 2019-022342 filed on Feb. 12, 2019 with Japan Patent Office is incorporated herein by reference in its entirety.

### BACKGROUND

### 1. Technological Field

The present invention relates to a resin composition, a method for producing the same, and a molded product. More specifically, the present invention relates to a resin composition that is excellent in fluidity at the time of melting, and a molded product excellent in impact strength and flame retardancy.

### 2. Description of the Related Art

For the purpose of reducing the environmental load by reducing the weight of materials used in home appliances, automobiles, and office automation equipment, and reducing the amount of materials used, the thickness of the products is being reduced. When the molded product is thinned, the problem is that the rigidity is lowered, and it is effective to add a fibrous filler to increase the rigidity. On the other hand, when the fibrous filler is added, a decrease in fluidity at the time of melting and a decrease in impact strength of the molded product become problems. In addition, when the molded product is thinned, the flame retardancy is also a problem, and the above-described home appliances and OA devices require flame retardancy in addition to strength.

Patent Document 1 (JP-A 2001-294741) discloses a resin composition containing a polycarbonate, a silicon-containing inorganic filler, and an ethylene-(meth)acrylate copolymer or an ethylene-(meth)acrylic acid copolymer. Although it is described that the color tone change at the time of molding is decreased, and the decrease of the molecular weight of the polycarbonate and the impact strength is suppressed, there is no mention of controlling the decrease in fluidity. In order to efficiently produce a molded product, fluidity at the time of melting is an important characteristic.

### SUMMARY

The present invention has been made in view of the above problems and circumstances. An object of the present invention is to provide a resin composition excellent in fluidity at the time of melting, capable of producing a molded product excellent in impact strength and flame retardancy, a production method thereof, and a molded product.

To achieve at least one of the above-mentioned objects according to the present invention, a resin composition that reflects an aspect of the present invention comprises at least a polycarbonate, a glass fiber, and an olefin-acrylate copolymer or an olefin-acrylic acid copolymer, wherein a mass ratio value (GF/0A) of a content of the glass fiber (GF) to a content of the olefin-acrylate copolymer or the olefin-acrylic acid copolymer (OA) is in the range of 1.0 to 6.0.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1A is a schematic diagram illustrating molecular behavior of a resin composition in a high temperature state

FIG. 1B is a schematic diagram illustrating molecular behavior of a resin composition in a low temperature state.

### DETAILED DESCRIPTION OF THE EMBODIMENTS

Hereinafter, one or more embodiments of the present invention will be described. However, the scope of the invention is not limited to the disclosed embodiments.

The resin composition of the present invention is a resin composition comprising at least a polycarbonate, a glass fiber, and an olefin-acrylate copolymer or an olefin-acrylic acid copolymer, wherein a mass ratio value (GF/OA) of a content of the glass fiber (GF) to a content of the olefin-acrylate copolymer or the olefin-acrylic acid copolymer (OA) is in the range of 1.0 to 6.0. This feature is a technical feature common to or corresponding to each of the following embodiments.

According to the present invention, it is possible to provide a resin composition excellent in fluidity at the time of melting, capable of producing a molded product excellent in impact strength and flame retardancy, a production method thereof, and a molded product.

The expression mechanism or action mechanism of the effect of the present invention is not clear, but it is presumed as follows.

Hereinafter, the expression mechanism of the effect will be described by taking an olefin-acrylate copolymer as an example. <Effect of Olefin-Acrylate Copolymer>

Because of the high polarity of the acrylate portion of the olefin(e.g., ethylene)-acrylate copolymer, it has high affinity and strong interfacial strength for both the matrix polymer polycarbonate (hereinafter also referred to as PC) and the glass fiber (hereinafter also referred to as GF). Thereby, impact strength increases.

On the other hand, since the ethylene portion has low polarity, it is incompatible with PC. In general, when there is incompatible ethylene, it is considered that the phase is separated and the strength is weakened. However, in the present invention, it has been newly found that strength is developed even though it is an incompatible component.

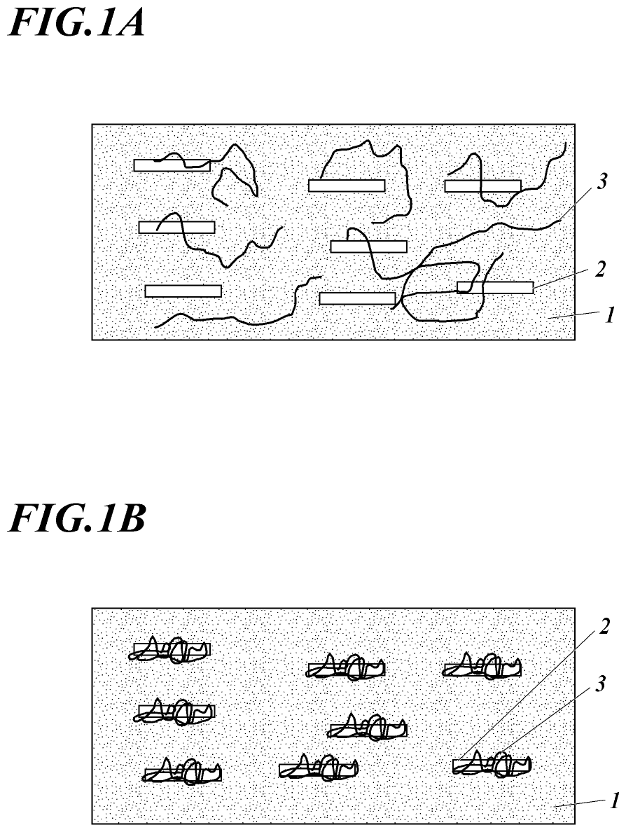

FIG. 1A and FIG. 1B are respectively a schematic diagram illustrating the molecular behavior of a resin composition containing a polycarbonate 1, a glass fiber 2, and an olefin-acrylate copolymer 3 in a high temperature state and a low temperature state.

FIG. 1A is a schematic diagram which indicates a state of the resin composition in a high temperature state (at the time of a flow). During molding, the temperature is high and the mobility of the olefin-acrylate copolymer 3 increases. It is presumed that the fluidity is increased by the molecular chains extending and entering between the molecular chains of PC1 and inhibiting the entanglement of the molecules.

FIG. 1B is a schematic diagram which indicates a state of the resin composition in a low temperature state (after molding). Upon cooling, the olefin part is folded and the copolymer is present at the interface between PC1 and GF2 from between the PC1 molecules. Thereby, the entanglement between the molecules of PC1 is induced, and it is assumed that the strength is maintained

As an embodiment of the present invention, from the viewpoint of expression of the effect of the present invention, it is preferable that the resin composition contains the polycarbonate in the range of 60 to 88 mass parts, the glass fiber in the range of 10 to 30 mass parts, and the olefin-acrylate copolymer or the olefin-acrylic acid copolymer in the range of 2 to 10 mass parts.

In order to obtain a desired strength, 10 to 30 mass parts of glass fiber is preferably added. In addition, the use of the glass fiber having an aspect ratio of 5 or more has a greater strength improvement effect than the particulate filler. The improvement effect is manifested at 10 mass parts or more. The occurrence of cracks between the matrix polymer and the glass fiber or between the glass fibers caused by too much amount of the glass fiber is suppressed when the fiber amount is 30 mass parts or less, and the impact strength is improved.

When the content of the olefin-acrylate copolymer or olefin-acrylic acid copolymer is in the range of 2 to 10 mass parts, the effect of improving the strength may be sufficiently exhibited. Further, a content of the olefin-acrylate copolymer or the olefin-acrylic acid copolymer is more preferably in the range of more than 5 mass parts to 10 mass parts or less. Compared to a content of 5 mass parts or less, the effect of improving impact strength and fluidity is large.

It is preferable that the olefin in the olefin-acrylate copolymer or olefin-acrylic acid copolymer is ethylene. When the olefin has no branched structure, it is folded during cooling and the volume of the olefin portion is reduced, so the strength is improved.

It is preferable that the alkyl group in the alkoxy group in the ester portion of the olefin-acrylate copolymer has 1 to 4 carbon atoms. When the carbon number is within this range, the balance of interaction with the glass filler and the polycarbonate is good. Especially, it is preferable that carbon number of the alkyl group is 4 (butyl).

Further, the resin composition of the present invention preferably contains an ester-based lubricant in the range of 0.1 to 2 mass parts per 100 mass parts of the resin composition. Although the detailed mechanism is unknown, the strength is higher than when other lubricants are used. In addition, due to the presence of the olefin-acrylate copolymer, release properties are good even when the amount used is small.

Further, it is preferable to contain a flame retardant in the range of 10 to 20 mass parts per 100 mass parts of the resin composition. By using 10 to 20 mass parts, sufficient flame retardancy may be obtained. The halogen type is not favorable in terms of environment, and the phosphorus system is preferable. More preferred are condensed phosphates. By using the condensed phosphate, it is easy to be compatible with other components, the flame retardancy may be increased, and the fluidity at the time of melting may be improved.

In addition, it is preferable that the styrenic resin is contained in the range of 1 to 30 mass parts per 100 mass parts of the resin composition because the impact strength may be maintained while providing fluidity.

The method for producing the resin composition of the present invention contains the step of: kneading the polycarbonate, the glass fiber, and the olefin-acrylate copolymer or the olefin-acrylic acid copolymer with a kneader, wherein the polycarbonate and the olefin-acrylate copolymer or the olefin-acrylic acid copolymer are introduced from an inlet of a barrel of the kneader, then the glass fiber is added to a latter half of the barrel.

By introducing glass fiber to the latter half of the barrel in the twin-screw kneader, the glass fiber becomes difficult to break, and the bending elastic modulus may be increased with a small amount of glass fiber used. Since the amount of glass fiber is small, it is possible to prevent a decrease in fluidity at the time of melting and a decrease in impact strength of the molded product.

The resin composition of the present invention is preferably processed and used for a molded product.

The above-described polycarbonate is preferably a reprocessed resin as an object for material recycling. Here, the “reprocessed resin” refers to a resin that has been recycled from a product once on the market (used product), and in the present invention, includes a resin that has been subjected to recycling preparatory processing such as separation and rough crushing. «Outline of Resin Composition of the Present Invention»

The resin composition of the present invention comprises at least a polycarbonate, a glass fiber, and an olefin-acrylate copolymer or an olefin-acrylic acid copolymer, wherein a mass ratio value (GF/OA) of a content of the glass fiber (GF) to a content of the olefin-acrylate copolymer or the olefin-acrylic acid copolymer (OA) is in the range of 1.0 to 6.0.

When the content of olefin-acrylate copolymer or olefin-acrylic acid copolymer is low, the olefin-acrylate copolymer or the olefin-acrylic acid copolymer does not exist sufficiently at the glass fiber interface, and the effect of improving fluidity and impact strength is not fully exhibited. On the other hand, when the content of the olefin-acrylate copolymer or the olefin-acrylic acid copolymer is large, the amount of the matrix resin that is not in contact with the glass fibers increases, and the impact strength of the matrix resin decreases. Therefore, the value of a mass ratio value (GF/OA) of a content of the glass fiber (GF) to a content of the olefin-acrylate copolymer or the olefin-acrylic acid copolymer (OA) is required to be in the range of 1.0 to 6.0.

Hereinafter, the components of the resin composition of the present invention will be described.

### [1] Polycarbonate

The polycarbonate referred to in the present invention is a polymer having a basic structure having a carbonate bond represented by the formula: —[—O—X—O—C(═O)—]—. In the formula, X represents a linking group and is generally a hydrocarbon. However, for the purpose of imparting various properties, X introduced with a hetero atom or a hetero bond may be used.

In general, aliphatic polycarbonates and aromatic polycarbonates are known as polycarbonates. Since an aliphatic polycarbonate has a low thermal decomposition temperature, and the temperature at which molding can be performed is low, methods to improve heat resistance are usually taken. For example, the thermal decomposition temperature is improved by reacting a terminal hydroxyl group of an aliphatic polycarbonate with an isocyanate compound. In addition, aliphatic polycarbonates produced by copolymerizing carbon dioxide and epoxide in the presence of a metal catalyst have excellent properties such as impact resistance, lightness, transparency, and heat resistance. Further, because it is biodegradable, it has a low environmental impact, and is an important resin as an engineering plastic material and a medical material because of its characteristics.

On the other hand, aromatic polycarbonate resins have excellent physical properties such as heat resistance, transparency, hygiene, and mechanical strength (e.g., impact strength), and are widely used in various applications. An “aromatic polycarbonate” refers to a polycarbonate in which each carbon directly bonded to a carbonate bond is an aromatic carbon. For example, a polycarbonate using a diol component containing an aromatic group such as bisphenol A may be used as a diol component constituting a polycarbonate. In particular, a polycarbonate using only a diol component containing an aromatic group is preferable. Known manufacturing methods thereof are: a method of reacting an aromatic dihydroxy compound such as bisphenol A with phosgene (interface method); and a method in which an aromatic dihydroxy compound such as bisphenol A or a derivative thereof and a carbonic diester compound such as diphenyl carbonate are subjected to an ester (exchange) reaction in a molten state (melting method or transesterification method).

In the present invention, it is particularly preferable to use an aromatic polycarbonate from the viewpoints of heat resistance, mechanical properties, and electrical characteristics.

As the aromatic polycarbonate, a linear polycarbonate and a branched polycarbonate are known. It is preferable to use properly according to the purpose or to use together. The branched polycarbonate has a lower melt flow rate than the linear polycarbonate having the same molecular weight. Therefore, a linear polycarbonate may be selected or the linear polycarbonate may be mixed with a linear polycarbonate to improve fluidity.

To obtain a branched aromatic polycarbonate, the following methods may be referred to. A branched aromatic polycarbonate having a branch derived from a polyfunctional compound having three or more functional groups reactive with carbonate diester in the molecule (described in JP-A 2006-89509 and WO 2012/005250) and a linking agent containing trifunctional or higher aliphatic polyol compound (described in WO 2014/024904) are subjected to a transesterification reaction in the presence of a transesterification catalyst under reduced pressure conditions to obtain a branched aromatic polycarbonate.

The aromatic polycarbonate is obtained by reacting a dihydric phenol and a carbonate precursor. Examples of the reaction method include an interfacial polymerization method, a melt transesterification method, a solid phase transesterification method of a carbonate prepolymer, and a ring-opening polymerization method of a cyclic carbonate compound.

Representative examples of the dihydric phenol include: hydroquinone, resorcinol, 4,4′-biphenol, 1,1-bis (4-hydroxyphenyl)ethane, 2,2-bis(4-hydroxyphenyl)propane (commonly called bisphenol A), 2,2-bis(4-hydroxy-3-methylphenyl)propane, 2,2-bis(4-hydroxyphenyl)butane, 1,1-bis(4-hydroxyphenyl)-1-phenylethane, 1,1-bis(4-hydroxyphenyl)cyclohexane, 1,1-bis(4-hydroxyphenyl)-3,3,5-trimethylcyclohexane, 2,2-bis(4-hydroxyphenyl)pentane, 4,4′-(p-phenylenediisopropylidene)diphenol, 4,4′-(m-phenylenediisopropylidene)diphenol, 1,1-bis(4-hydroxyphenyl)-4-isopropylcyclohexane, bis(4-hydroxyphenyl)oxide, bis(4-hydroxyphenyl)sulfide, bis(4-hydroxyphenyl)sulfoxide, bis(4-hydroxyphenyl)sulfone, bis (4-hydroxyphenyl)ketone, bis(4-hydroxyphenyl)ester, bis(4-hydroxy-3-methylphenyl)sulfide, 9,9-bis(4-hydroxyphenyl)fluorene and 9,9-bis(4-hydroxy-3-methylphenyl)fluorene. A preferred dihydric phenol is bis(4-hydroxyphenyl)alkane, and bisphenol A (hereinafter sometimes abbreviated as “BPA”) is particularly preferred from the viewpoint of impact resistance, and is widely used.

In the present invention, in addition to bisphenol A-based polycarbonate, which is a general-purpose polycarbonate, it is possible to use a special polycarbonate produced using other dihydric phenols.

The polycarbonates (homopolymer or copolymer) produced by the following component as a part or all of the dihydric phenol component is suitable for applications in which dimensional changes due to water absorption and shape stability requirements are particularly severe. Examples of the dihydric phenol component are: 4,4′-(m-phenylenediisopropylidene)diphenol (hereinafter sometimes abbreviated as “BPM”), 1,1-bis(4-hydroxyphenyl)cyclohexane, 1,1-bis(4-hydroxy)phenyl)-3,3,5-trimethylcyclohexane (hereinafter sometimes abbreviated as “Bis-TMC”), 9,9-bis(4-hydroxyphenyl)fluorene and 9,9-bis(4-hydroxy-3-methylphenyl)fluorene (hereinafter sometimes abbreviated as “BCF”).

These polycarbonates may be used alone or in combination of two or more. Moreover, these may be used by mixing with a bisphenol A type polycarbonate generally used.

The production methods and properties of these polycarbonates are described in detail in, for example, JP-A 6-172508, JP-A 8-27370, JP-A 2001-55435, and JP-A 2002-117580.

The glass transition temperature Tg of polycarbonate is preferably 160 to 250° C., more preferably 170 to 230° C.

The Tg (glass transition temperature) is a value obtained by differential scanning calorimetry (DSC) measurement based on JIS K7121.

As the carbonate precursor, carbonyl halide, carbonate diester, or haloformate is used, and specifically, phosgene, diphenyl carbonate, or dihaloformate of dihydric phenol may be mentioned.

In producing an aromatic polycarbonate by an interfacial polymerization method using a dihydric phenol and a carbonate precursor, a catalyst, a terminal terminator, or an antioxidant for preventing the dihydric phenol from being oxidized may be used as needed. The aromatic polycarbonate resin according to the present invention include: a branched polycarbonate resin copolymerized with trifunctional or higher polyfunctional aromatic compounds, a polyester carbonate copolymerized with aromatic or aliphatic (including alicyclic) bifunctional carboxylic acids, a copolymerized polycarbonate copolymerized with a bifunctional alcohol (including an alicyclic group), and a polyester carbonate copolymerized together with such a difunctional carboxylic acid and a difunctional alcohol. A mixture which mixed 2 or more types of the obtained aromatic polycarbonate may be used.

The branched polycarbonate increases the melt tension of the resin composition of the present invention, and may improve the molding processability in extrusion molding, foam molding and blow molding based on such characteristics. As a result, a molded product by these molding methods, which is superior in dimensional accuracy, is obtained.

Preferable examples of a trifunctional or higher polyfunctional aromatic compound used in branched polycarbonate resins are: 4,6-dimethyl-2,4,6-tris(4-hydroxydiphenyl)heptane, 2,4,6-trimethyl-2,4,6-tris(4-hydroxyphenyl)heptane, 1,3,5-tris(4-hydroxyphenyl)benzene, 1,1,1-tris(4-hydroxyphenyl)ethane, 1,1,1-tris(3,5-dimethyl-4-hydroxyphenyl)ethane, 2,6-bis(2-hydroxy-5-methylbenzyl)-4-methylphenol, and a trisphenol such as 4-{4-[1,1-bis(4-hydroxyphenyl)ethyl]benzene}-α,α-dimethylbenzylphenol. Other examples of the polyfunctional aromatic compound are: phloroglucin, phloroglucid, tetra(4-hydroxyphenyl)methane, bis(2,4-dihydroxyphenyl)ketone, 1,4-bis(4,4-dihydroxytriphenylmethyl)benzene, trimellitic acid, pyromellitic acid, and benzophenone tetracarboxylic acid and its acid chloride. Of these, 1,1,1-tris(4-hydroxyphenyl)ethane and 1,1,1-tris(3,5-dimethyl-4-hydroxyphenyl)ethane are preferable, and 1,1,1-tris(4-hydroxyphenyl)ethane is more preferred.

The structural unit derived from the polyfunctional aromatic compound in the branched polycarbonate resin is 0.03 to 1 mol %, preferably 0.07 to 0.7 mol %, more preferably 0.1 to 0.4 mol % in the total of 100 mol % of the structural unit derived from dihydric phenol and the structural unit derived from such polyfunctional aromatic compound.

In addition, the branched structural unit is not only derived from a polyfunctional aromatic compound, but may also be derived without using a polyfunctional aromatic compound, such as a side reaction during a melt transesterification reaction. The ratio of such a branched structure may be calculated by ¹H-NMR measurement.

The aliphatic bifunctional carboxylic acid is preferably α,ω-dicarboxylic acid. Examples of the aliphatic bifunctional carboxylic acid are: linear saturated aliphatic dicarboxylic acids such as sebacic acid (decanedioic acid), dodecanedioic acid, tetradecanedioic acid, octadecanedioic acid, and icosanedioic acid; acyclic dicarboxylic acid such as cyclohexanedicarboxylic acid. As the bifunctional alcohol, an alicyclic diol is more preferable, and examples thereof include cyclohexanedimethanol, cyclohexanediol, and tricyclodecane dimethanol. Further, a polycarbonate-polyorganosiloxane copolymer obtained by copolymerizing polyorganosiloxane units may also be used.

The reaction by the interfacial polymerization method is usually a reaction between a dihydric phenol and phosgene, and is reacted in the presence of an acid binder and an organic solvent. As the acid binder, for example, alkali metal hydroxides such as sodium hydroxide and potassium hydroxide, and pyridine are used.

As the organic solvent, for example, halogenated hydrocarbons such as methylene chloride and chlorobenzene are used.

In addition, catalysts such as tertiary amines and quaternary ammonium salts may be used to promote the reaction. As the molecular weight regulator, it is preferable to use monofunctional phenols such as phenol, p-tert-butylphenol and p-cumylphenol. Examples of the monofunctional phenol include: decylphenol, dodecylphenol, tetradecylphenol, hexadecylphenol, octadecylphenol, eicosylphenol, docosylphenol, and triacontylphenol. These monofunctional phenols having a relatively long chain alkyl group are effective when improvement in melt flow rate and hydrolysis resistance is required.

The reaction temperature is usually 0 to 40° C., the reaction time is several minutes to 5 hours, and the pH during the reaction is usually kept at 10 or higher.

The reaction by the melt transesterification method is usually a transesterification reaction between a dihydric phenol and a carbonic acid diester. A dihydric phenol and a carbonic acid diester are mixed in the presence of an inert gas, and reacted at 120 to 350° C. under reduced pressure. The degree of vacuum is changed stepwise, and finally the phenols produced at 133 Pa or less are removed from the system. The reaction time is usually about 1 to 4 hours.

Examples of the carbonate diester include: diphenyl carbonate, dinaphthyl carbonate, bis(diphenyl) carbonate, dimethyl carbonate, diethyl carbonate, and dibutyl carbonate. Of these, diphenyl cathonate is preferred.

A polymerization catalyst may be used to speed up the polymerization rate. The polymerization catalysts are catalysts usually used for esterification and transesterification. Examples thereof are: hydroxides of alkali metals and alkaline earth metals such as sodium hydroxide and potassium hydroxide, hydroxides of boron and aluminum, alkali metal salts, alkaline earth metal salts, quaternary ammonium salts, alkoxides of alkali metals and alkaline earth metals, organic acid salts of alkali metals and alkaline earth metals, zinc compounds, boron compounds, silicon compounds, germanium compounds, organotin compounds, lead compounds, antimony compounds, manganese compounds, titanium compounds, and zirconium compounds. The catalyst may be used alone and may be used in combination of 2 or more types. The amount of these polymerization catalysts used is preferably selected in the range of 1×10⁻⁹ to 1×10⁻⁵ equivalent, more preferably 1×10⁻⁸ to 5×10⁻⁶ equivalent, with respect to 1 mol of dihydric phenol as a raw material.

In the reaction by the melt transesterification method, for example, 2-chlorophenylphenyl carbonate, 2-methoxycathonylphenylphenyl carbonate and 2-ethoxycarbonylphenylphenyl cathonate may be added at the later stage or after completion of the polycondensation reaction in order to reduce phenolic end groups.

Further, in the melt transesterification method, it is preferable to use a deactivator that neutralizes the activity of the catalyst. The amount of the deactivator is preferably in the range of 0.5 to 50 mol with respect to 1 mol of the remaining catalyst. Further, it is used in a proportion of 0.01 to 500 ppm, more preferably 0.01 to 300 ppm, and particularly preferably 0.01 to 100 ppm with respect to the aromatic polycarbonate resin after polymerization. Preferred examples of the deactivator include: phosphonium salts such as tetrabutylphosphonium dodecylbenzenesulfonate and ammonium salts such as tetraethylammonium dodecylbenzyl sulfate.

Details of other reaction methods are well known in various documents and patent publications.

The weight average molecular weight of the polycarbonate is not particularly limited, but is preferably in the range of 20,000 to 60,000, more preferably in the range of 30,000 to 57,000, and still more preferably in the range of 35,000 to 55,000.

### <Weight Average Molecular Weight>

The weight average molecular weight is measured by the following procedure. The resin to be measured is dissolved in tetrahydrofuran (THF) to a concentration of 1 mg/mL, and then filtered using a membrane filter with a pore size of 0.2 μm, and the resulting solution is used as a sample for GPC measurement. GPC analysis conditions indicated below are adopted for the GPC measurement conditions, and a weight average molecular weight of a resin contained in the sample is measured.

### (GPC Measurement Conditions)

As a GPC apparatus, “HLC-8320GPC/UV-8320” (made by Tosoh Corporation) was used. Two pieces of “TSKgel, Supermultipore HZ-H” (4.6 mm ID×15 cm, made by Tosoh Corporation) were used as columns Tetrahydrofuran (THF) was used as an eluent. The analysis was performed at a flow rate of 0.35 mL/min, a sample injection amount of 20 μL, and a measurement temperature of 40° C. using a RI detector. The calibration curve was obtained by using “Polystyrene standard sample, TSK standard” manufactured by Tosoh Corporation. Ten samples of “A-500,” “F-1,” “F-10,” “F-80,” “F-380,” “A-2500,” “F-4,” “F-40,” “F-128” and “F-700” were use. The data collection interval in sample analysis was set to be 300 ms.

When the polycarbonate has a weight average molecular weight in the range of 20,000 to 60,000, it becomes an aromatic polycarbonate resin composition with excellent molding processability and excellent balance between mechanical properties such as heat resistance and fluidity. It becomes a polycarbonate resin composition that is particularly excellent in mechanical properties and surface appearance that are less likely to cause sink marks due to strength reduction or post-shrinkage after taking out the mold during molding.

### [2] Glass Fiber

The glass fiber according to the present invention refers to a fibrous filler having an average diameter of 20 μm or less and an aspect ratio (fiber length/average diameter) of 5 or more. The glass fiber increases the rigidity of the resin composition by being dispersed in the polycarbonate which is the resin according to the present invention.

The aspect ratio (fiber length/average diameter) of the glass fiber is preferably 5 or more from the viewpoint of increasing the rigidity of the resin composition. Moreover, it is preferable that the aspect ratio of glass fiber is less than 50 from the viewpoint of dispersibility of glass fiber.

From the viewpoint of increasing the strength of the resin composition, the length of the glass fiber is preferably 100 μm or more, and more preferably 150 μm or more. Moreover, it is preferable that the length of glass fiber is less than 600 μm from the viewpoint of dispersibility.

The average diameter of the glass fiber is preferably in the range of 5 to 20 μm in order to prevent appearance deterioration in the molded body.

The length, average diameter, and aspect ratio of the glass fiber can be determined, for example, by observing and measuring the glass fiber with a laser microscope (VX-X250; made by Keyence Corporation). Specifically, for example, the resin is removed from the resin composition, and the fiber length and fiber diameter of 50 glass fibers selected at random are measured. And the average value of the length of 50 glass fibers is determined as the length of glass fiber. Moreover, the average value of the diameter of 50 glass fibers is determined as the diameter of glass fiber. Furthermore, the aspect ratio of each glass fiber may be calculated, and the average value of the aspect ratios of 50 glass fibers may be calculated as the aspect ratio of the glass fibers.

The method for forming the glass fiber into the predetermined shape described above may be performed by any method. The length of the glass fiber may be prepared using, for example, a ball mill. Examples of media materials used in ball mills include glass, alumina, zircon, zirconia, steel, and flint stone. The media material is preferably zircon or zirconia. Further, the shape of the media is usually a sphere, and the diameter is preferably 4 to 8 mm.

The content of the glass fiber relative to 100 mass parts of the resin is preferably 10 mass parts or more from the viewpoint of increasing the strength of the resin composition. Moreover, it is preferable that it is 30 mass parts or less from the viewpoint of preventing deterioration of the fluidity at the time of melting and the impact strength of a molded product.

The content of the glass fiber content relative to the cured resin may be determined, for example, by melting the cured resin composition and removing the thermoplastic resin from the resin composition, and then measuring the glass fiber.

Commercially available glass fibers may be used, and examples thereof include glass fibers CS 3 PE-948, CSF 3 PE-455, and CHG 3 PA-830 (all manufactured by Nitto Boseki Co., Ltd.).

### [3] Olefin-Acrylate Copolymer and Olefin-Acrylic Acid Copolymer

An olefin-acrylate copolymer and an olefin-acrylic acid copolymer according to the present invention include an olefin-(meth)acrylate copolymer and an olefin-(meth)acrylic acid copolymer.

The olefin in the olefin-acrylate copolymer and the olefin-acrylic acid copolymer is preferably ethylene. The olefin without a branched structure is folded during cooling and the volume of the olefin portion is reduced, so it is preferable from the viewpoint of improving the impact strength.

It is preferable that an alkyl group in an alkoxy group in an ester portion of the olefin-acrylate copolymer has 1 to 4 carbon atoms. When the carbon number is within this range, the balance of interaction with the glass filler and the polycarbonate is good. Especially, it is preferable that carbon number of the alkyl group is 4 (butyl).

In the resin composition of the present invention, the ethylene-acrylate copolymer and the ethylene-acrylic acid copolymer may be appropriately selected from known ethylene-acrylate copolymers, ethylene-methacrylate copolymers, ethylene-acrylic acid copolymers, and ethylene-methacrylic acid copolymers.

Examples of the monomer for (meth)acrylate are as follows. Examples the monomer for the acrylate include methyl acrylate, ethyl acrylate, propyl acrylate, butyl acrylate, amino acrylate, hexyl acrylate, octyl acrylate, 2-ethylhexyl acrylate, cyclohexyl acrylate, dodecyl acrylate, octadecyl acrylate, phenyl acrylate, and benzyl acrylate. Examples of the monomer for the methacrylate include methyl methacrylate, ethyl methacrylate, propyl methacrylate, butyl methacrylate, amino methacrylate, hexyl methacrylate, octyl methacrylate, 2-ethylhexyl methacrylate, cyclohexyl methacrylate, dodecyl methacrylate, octadecyl methacrylate, phenyl methacrylate, and benzyl methacrylate. Of these, butyl acrylate and butyl methacrylate are preferable.

When the content of the olefin-acrylate copolymer or olefin-acrylic acid copolymer is in the range of 2 to 10 mass parts, the effect of improving the impact strength may be sufficiently exhibited. Further, the content of the olefin-acrylate copolymer or the olefin-acrylic acid copolymer is more preferably in the range of more than 5 mass parts to 10 mass parts or less. This is because the effect of improving impact strength and fluidity is greater than the content of 5 mass parts or less.

### [4] Ester Lubricant

There is no particular limitation on the ester lubricant used in the present invention. Examples thereof are: ester compounds produced by fatty acids having 12 to 32 carbon atoms (such as lauric acid, palmitic acid, heptadecanoic acid, stearic acid, oleic acid, arachidic acid, and behenic acid) with monohydric aliphatic alcohols (such as palmitic alcohol, stearyl alcohol, and behenyl alcohol) or polyhydric aliphatic alcohols (such as glycerin, pentaerythritol, dipentaerythritol, and sorbitan); and complex ester compounds produced by fatty acids or polybasic organic acid with monohydric aliphatic alcohols or polyhydric aliphatic alcohols. Specific examples of the fatty acid ester lubricant include cetyl palmitate, butyl stearate, stearyl stearate, stearyl citrate, glycerol monocaprylate, glycerol monocaprate, glycerol monolaurate, glycerol monopalmitate, glycerol dipalmitate, glycerol monostearate, glycerol distearate, glycerol tristearate, glycerol monooleate, glycerol dioleate, glycerol trioleate, glycerol monolinoleate, glycerol monobehenate, glycerol mono-12-hydroxystearate, glycerol diacetomonostearate, glycerol citrate, pentaerythritol adipic acid stearate, montanic acid partially saponified ester, pentaerythritol tetrastearate, dipentaerythritol hexastearate, and sorbitan tristearate. These ester lubricants may be used alone or in combination of two or more. Among these, pentaerythritol tetrastearate can be suitably used.

The ester-based lubricant is preferably used in the range of 0.1 to 2 mass parts per 100 mass parts of the resin composition.

### [5] Flame Retardant

Examples of the flame retardant include: halogen flame retardants such as halogenated bisphenol A polycarbonate, brominated bisphenol epoxy resin, brominated bisphenol phenoxy resin, and brominated polystyrene; condensed phosphate flame retardants; organometallic salt flame retardants such as dipotassium diphenylsulfone-3,3′-disulfonate, potassium diphenylsulfone-3-sulfonate, and potassium perfluorobutanesulfonate; and polyorganosiloxane flame retardants. Among them, condensed phosphate flame retardants are preferable. The content of the flame retardant is usually 1 to 30 mass parts, preferably 5 to 25 mass parts, and more preferably 10 to 20 mass parts with respect to 100 mass parts of the total of the thermoplastic resin and the compound according to the present invention.

### [6] Styrenic Resin

In the present invention, the styrenic resin means a polymer containing at least a styrene monomer as a monomer component. Here, the styrene monomer means a monomer having a styrene skeleton in its structure. It is preferably contained in the range of 10 to 20 mass parts mass per 100 mass parts of the resin composition of the present invention.

The styrene monomer is not particularly limited as long as it has a styrene skeleton in its structure. Examples thereof include aromatic vinyl monomers such as: styrene; nuclear alkyl-substituted styrene such as o-methylstyrene, m-methylstyrene, p-methylstyrene, 2,4-dimethylstyrene, ethylstyrene, and p-tert-butylstyrene; and α-alkyl-substituted styrene such as α-methylstyrene and α-methyl-p-methylstyrene. Among them, styrene is preferable.

The styrenic resin may be a homopolymer of a styrene monomer or a copolymer of a styrene monomer and another monomer component. Exampled of the monomer component copolymerizable with a styrenic monomer include: unsaturated carboxylic acid alkyl ester monomers such as alkyl methacrylate monomers (e.g., methyl methacrylate, cyclohexyl methacrylate, methylphenyl methacrylate, and isopropyl methacrylate) and alkylacrylate monomers (e.g., Methyl acrylate, ethyl acrylate, butyl acrylate, 2-ethylhexyl acrylate, and cyclohexyl acrylate); unsaturated carboxylic acid monomers such as methacrylic acid, acrylic acid, itaconic acid, maleic acid, fumaric acid, and cinnamic acid; unsaturated dicarboxylic acid anhydride monomers such as maleic anhydride, itaconic acid, ethyl maleic acid, methyl itaconic acid, and chloromaleic acid; unsaturated nitrile monomers such as acrylonitrile and methacrylonitrile; and conjugated diene monomers such as 3-butadiene, 2-methyl-1,3-butadiene (isoprene), 2,3-dimethyl-1,3-butadiene, 1,3-pentadiene, and 1,3-hexadiene. Two or more of these may be copolymerized. The copolymerization ratio of such other monomer components is preferably 50 mass % or less, more preferably 40 mass % or less, and further preferably 30 mass % or less with respect to the styrene monomer.

As the styrenic resin, styrene-acrylonitrile copolymer, styrene-methacrylic acid copolymer, and styrene-maleic anhydride copolymer are particularly excellent in terms of properties required for optical materials such as heat resistance and transparency. Therefore, they are preferable.

In the case of a styrene-acrylonitrile copolymer, the copolymerization ratio of acrylonitrile in the copolymer is preferably 1 to 40 mass %, more preferably 1 to 30 mass %, and still more preferably 1 to 25 mass % It is preferable that the copolymerization ratio of acrylonitrile in the copolymer is in the range of 1 to 40 mass % because a copolymer having excellent transparency tends to be obtained, and this is preferable.

In the case of a styrene-methacrylic acid copolymer, the copolymerization ratio of methacrylic acid in the copolymer is preferably 0.1 to 50 mass %, more preferably 0.1 to 40 mass %, and still more preferably 0.1 to 30 mass %. When the copolymerization ratio of methacrylic acid in the copolymer is 0.1 mass % or more, a copolymer excellent in heat resistance tends to be obtained, and when it is 50 mass % or less, a copolymer having excellent transparency tends to be obtained, and this is preferable.

In the case of a styrene-maleic anhydride copolymer, the copolymerization ratio of maleic anhydride in the copolymer is preferably 0.1 to 50 mass %, more preferably 0.1 to 40 mass %, still more preferably 0.1 to 30 mass %. When the copolymerization ratio of maleic anhydride in the copolymer is 0.1 mass % or more, a copolymer excellent in heat resistance tends to be obtained. When it is 50 mass % or less, a copolymer having excellent transparency is obtained, and this is preferable.

### [7] Other Resin Components

Other resin components may also be used in the resin composition of the present invention.

Moreover, a thermoplastic polyester resin may also be mixed with the resin mixture of the present invention. Examples thereof include: a polyethylene terephthalate resin (PET), a polypropylene terephthalate resin (PPT), a polybutylene terephthalate resin (PBT), a polyhexylene terephthalate resin, a polyethylene naphthalate resin (PEN), a polybutylene naphthalate resin (PBN), a poly(1,4-cyclohexanedimethylene terephthalate) resin (PCT), and a polycyclohexyl cyclohexylate (PCC). Among these, a polyethylene terephthalate resin (PET) and a polybutylene terephthalate resin (PBT) are preferable from the viewpoint of melt flow rate and impact resistance.

It is also preferable to add an elastomer to the resin composition of the present invention. By blending the elastomer, the impact resistance of the resulting resin composition may be improved.

In view of mechanical properties and surface appearance, examples of the elastomer preferably used in the present invention are: polybutadiene rubber, butadiene-styrene copolymer, polyalkyl acrylate rubber, polyorganosiloxane rubber, and IPN (Interpenetrating Polymer Network) type composite rubber composed of polyorganosiloxane rubber and polyalkyl acrylate rubber.

It is also preferable to appropriately use a resin additive in the resin composition of the present invention. Examples thereof are: a thermal stabilizer (e.g., a phosphorus compound), an antioxidant (e.g., a hindered phenol antioxidant), a mold release agent (e.g., an aliphatic carboxylic acid, an ester of an aliphatic carboxylic acid and an alcohol, an aliphatic hydrocarbon compound, and a polysiloxane silicone oil), a filler, a glass fiber, a UV absorber, a dye and a pigment (including carbon black), titanium oxide, an antistatic agent, an antifogging agent, a lubricant, an antiblocking agent, a melts flow rate improver, a plasticizer, a dispersant, and antibacterial agent. In addition, 1 type of resin additive may be mixed, and 2 or more types may be mixed by arbitrary combinations and ratios.

### [8] Method for Producing Resin Composition

The method for producing the resin composition of the present invention preferably comprises the steps of: preparing a polycarbonate, a glass fiber, and an olefin-acrylate copolymer or an olefin-acrylic acid copolymer; and mixing the glass fiber and the olefin-acrylate copolymer or the olefin-acrylic acid copolymer with the polycarbonate as a host material by applying a shearing force with a melt kneader.

Specific examples of the kneader are KRC kneader (manufactured by Kurimoto Ltd.); PolyLab system (manufactured by HAAKE Co., Ltd.); Laboplast Mill (manufactured by Toyo Seiki Seisakusho KK); NAUTA mixer Buss Co Kneader (manufactured by Buss Co., Ltd.); TEM Extruder (manufactured by Toshiba Machine Co., Ltd.); TEX Twin-screw kneader (manufactured by Nippon Steel Co., Ltd.); PCM kneader (manufactured by Ikegai Co., Ltd.); Three roll mill, mixing roll mill, kneader (manufactured by Inoue Seisakusho Co., Ltd.); KNEADEX (Mitsui Mining Co., Ltd.); MS pressure press kneader, Kneader Ruder (Moriyama Seisakusho Co., Ltd.); Banbury mixer (Kobe Steel Co., Ltd.).

In the production method of the resin composition of the present invention, and in the step of kneading the polycarbonate, the glass fiber, and the olefin-acrylate copolymer or the olefin-acrylic acid copolymer with a kneader, it is preferable to have a step in which the polycarbonate and the olefin-acrylate copolymer or the olefin-acrylic acid copolymer are introduced from an inlet of a barrel of the kneader, then the glass fiber is added to a latter half of the barrel.

By introducing the glass fiber from the latter half of the twin-screw kneader, the glass fiber becomes difficult to break, and the bending elastic modulus can be increased with a small amount of glass fiber used. Since the amount of glass fiber is small, it is possible to prevent a decrease in fluidity at the time of melting and a decrease in impact strength of the molded product.

The “latter half of the barrel,” which is a second charging position, is preferably 60 to 90% of the barrel position. When it is less than 60%, the glass fiber tends to break due to the share of kneading, and the strength is not easily increased sufficiently.

When the position is 60% to 90% of the barrel position, the interaction between the glass fiber and the olefin-acrylate copolymer may facilitate the presence of the olefin-acrylate copolymer in the vicinity of the glass fiber, thereby increasing the impact strength. When the glass fiber is added after exceeding 90%, the olefin-acrylate copolymer does not collect sufficiently in the vicinity of the glass fiber, so the impact strength tends to decrease. Therefore, the position is preferably 60% to 90% of the barrel position.

### [9] Molded Product

Next, the resin composition of the present invention is heated and melted by a molding machine and injection molded to obtain a reprocessed resin molded product. The resin composition of the present invention is excellent in moldability because it is uniformly heated and pressured in the molding machine by being excellent fluidity at the time of melting.

The method for molding as a molded product is not particularly limited, and a conventionally known molding method may be adopted. Examples thereof are: injection molding method, injection compression molding method, extrusion molding method, profile extrusion method, transfer molding method, hollow molding method, gas assist hollow molding method, blow molding method, extrusion blow molding, IMC (in-mold coating molding) molding method, rotational molding method, multilayer molding method, two-color molding method, insert molding method, sandwich molding method, foam molding method, and pressure molding method.

Among these, it is preferable to produce a molded product using an injection molding method.

Since the resin composition of the present invention is excellent in flexural modulus, it is useful as an exterior material or interior material for OA equipment. Moreover, since it may be made thinner than conventional resin products, weight reduction is expected.

The molded product obtained by molding the resin composition may be suitably used for various applications such as electric and electronic parts, home appliance parts, automobile parts, various building materials, containers, and miscellaneous goods.

### EXAMPLES

Hereinafter, the present invention will be specifically described by way of examples, but the present invention is not limited thereto. In addition, although the term “part” or “%” is used in an Example, unless otherwise indicated, it represents “mass part” or “mass %”

### Example 1

A resin composition was prepared using the following materials.

Polycarbonate (PC): SD POLYCA 301-10 (Sumitomo Polycarbonate Co., Ltd.)

Glass fiber (GF): CSF 3 PE-455 (Nitto Boseki Co., Ltd.)

Talc: MICRO ACE P-3 (Nippon Talc Co., Ltd.)

Olefin-acrylate copolymer: LOTRYL EBA 35BA40 (ethylene-butyl acrylate copolymer, Arkema Co., Ltd.)

Olefin-acrylic acid copolymer: LOTRYL EMA 29BA03 (ethylene-methyl acrylate copolymer, Arkema Co., Ltd.)

Olefin-acrylic acid copolymer: A-0540 (ethylene-acrylic acid copolymer, Honeywell Co., Ltd.)

Flame retardant: PX-200 (condensed phosphate compound, Daihachi Chemical Industry Co., Ltd.)

Lubricant: LUNAC S-90V (stearic acid, Kao Corporation)

Lubricant: UNISTAR H476 (pentaerythritol tetrastearate, NOF Corporation)

Styrene resin: PSJ-POLYSTYRENE H9152 (PS Japan Co., Ltd.)

### <Preparation of Resin Composition 1 and Molded Product>

87 5 mass parts of polycarbonate (PC) and 2.5 mass parts of ethylene-butyl acrylate copolymer (EBA 35BA40) were added to an inlet of the barrel of a twin-screw kneader KTX-30 (first time), and kneading was performed at a temperature of 250° C. with a rotation of 250 rpm. 10 mass parts of glass fiber (GF) was further mixed from the latter half of the twin-screw kneader (position corresponding to 70% of the barrel length, hereinafter also referred to as “second charging position”) to obtain a resin composition 1. After drying the resin composition 1 at 80° C. for 4 hours or more, by using a JSW-110 injection molding machine, a bending test piece according to JIS 7171, an impact test piece according to JIS K7110, and an injection molded product having a size of 100 mm×10 mm×1.6 m for UL test molded were produced. The molding conditions were set as: a cylinder temperature of 250° C., a mold temperature of 50° C., an injection speed of 30 mm/sec, and a holding pressure of 50 MPa.

### <Preparation of Resin Compositions 2 to 20 of the Present Invention, Resin Compositions 21 to 26 of the Comparative Examples, and Molded Products>

In the same manner as in the preparation of the resin composition 1 and the production of the molded product, the materials described in Table I and Table II were kneaded at the ratios described in Table I and Table II, and the resin compositions 2 to 20 the present invention and the resin compositions 21 to 26 of the comparative examples were prepared, and molded products were prepared. In addition, the numbers related to the material in the table represent a mass part, respectively. «Evaluation»

### (1) Measurement of Aspect Ratio of Glass Fiber

The aspect ratio (fiber length/average diameter) of glass fiber (GF) was measured by the following method using each resin composition.

<Measurement of Aspect ratio of Glass Fiber>

The length, average diameter, and aspect ratio of the glass fiber were determined by observing and measuring the glass fiber with a laser microscope (VX-X250; made by Keyence Corporation). Specifically, the resin was removed from the resin composition, and the fiber length and fiber diameter of 50 glass fibers selected at random were measured. And the average value of the length of 50 glass fibers was determined as the length of glass fiber. Moreover, the average value of the diameter of 50 glass fibers was determined as the diameter of glass fiber. Furthermore, the aspect ratio of each glass fiber was calculated, and the average value of the aspect ratios of 50 glass fibers was calculated as the aspect ratio of the glass fibers.

### (2) Measurement of Bending Elastic Modulus

The bending elastic modulus was evaluated based on the following criteria by measuring the bending elastic modulus in accordance with JIS K7171 (2008). The test piece was measured and the bending elastic modulus was obtained in accordance with JIS K7171, under the conditions of a bending speed of 100 mm/min, a jig tip R of 5 mm, a span interval of 100 mm, and a test piece (width 50 mm×length 150 mm×thickness 4 mm). The measuring device was Tensilon RTC-1225A manufactured by Orientec Co., Ltd., and the temperature was 23° C. and the humidity was 55% RH.

AA: 4000 MPa or more

BB: 3500 MPa or more and less than 4000 MPa

CC: Less than 3500 MPa

The bending elastic modulus is preferably from BB to AA

### (3) Impact Strength

The impact strength was evaluated by calculating the impact strength by an Izod impact test based on JIS K7110 (1999) and evaluating it according to the following criteria.

The impact test was performed after leaving the test piece for 16 hours at a temperature of 23° C. and a humidity of 50% RH. The used impact tester was a digital impact tester DG-UB type (manufactured by Toyo Seiki Seisakusho Co., Ltd.) under the conditions of a temperature of 23° C. and a humidity of 55% RH.

AA: 7 kJ/m² or more

BB: 4 kJ/m² or more and less than 7 k kJ/m²

CC: Less than 4k kJ/m²

The impact strength is preferably from BB to AA.

### (4) Fluidity

Using a Capillograph 1D manufactured by Toyo Seiki Seisakusho Co., Ltd., the fluidity was evaluated by the shear viscosity at a temperature of 250° C. and a shear rate of 1×10³/sec.

AA: Less than 350 Pa·s

BB: 350 Pa·s or more and less than 500 Pa·s

CC: 500 Pa·s or more

The fluidity is preferably from BB to AA.

### (4) Flame Retardancy

Evaluation of flame retardancy was performed by conditioning an injection molded product for UL testing molded product formed in a size of 100 mm×10 mm×1.6 m for 48 hours in a temperature-controlled room at 23° C. and humidity 50% RH. The test was conducted in accordance with the UL94 test (combustion test of plastic materials for equipment parts) defined by the US Underwriters Laboratories (UL) (in the USA).

Here, the “UL94 test” is a method for evaluating the flame retardancy from the after-flame time and the drip property after the flame of the burner is indirectly fired for 10 seconds on a resin molded body of a predetermined size held vertically. And the flame retardancy was evaluated according to the following criteria.

AA: V-0

BB: V-1 or V-2

CC: Out of specification

The flame retardancy is preferably from BB to AA.

The structures and evaluation results of the above resin compositions are indicated in Table I and Table II below.

TABLE I

| | | | Resin composition No. | | | | | | | |
|---|---|---|---|---|---|---|---|---|---|---|
| | | | 1 | 2 | 3 | 4 | 5 | 6 | 7 | 8 |
| Material | Product name | | *1 | *1 | *1 | *1 | *1 | *1 | *1 | *1 |
| PC | SDPOLYCA301-10 | | 87.5 | 84.9 | 80 | 82.5 | 72.5 | 65 | 62.5 | 60 |
| GF | CSF3PE-455 | | 10 | 10 | 10 | 15 | 20 | 30 | 30 | 30 |
| Talc | MICRO ACE P-3 | | — | — | — | — | — | — | — | — |
| Olefin- | EBA35BA40 | | 2.5 | 5.1 | 10 | 2.5 | 7.5 | 5 | 7.5 | 10 |
| acrylate | EMA29MA03 | | — | — | — | — | — | — | — | — |
| (OA) | | | | | | | | | | |
| Olefin- | A-C450 | | — | — | — | — | — | — | — | — |
| acrylic | | | | | | | | | | |
| acid (OA) | | | | | | | | | | |
| Mass ratio value (GF/OA) | | | 5.0 | 2.0 | 1.0 | 6.0 | 2.7 | 6.0 | 4.0 | 3.0 |
| Lubricant | UNISTAR H476 | | — | — | — | — | — | — | — | — |
| | LUNAC S-90V | | — | — | — | — | — | — | — | — |
| Flame | PX-200 | | — | — | — | — | — | — | — | — |
| retardant | | | | | | | | | | |
| Styrenic | H9152 | | — | — | — | — | — | — | — | — |
| resin | | | | | | | | | | |
| Evaluation | Aspect ratio of GF | | 33 | 34 | 33 | 32 | 32 | 29 | 30 | 30 |
| | Bending | Measurement | 4100 | 4100 | 4050 | 5200 | 6050 | 8700 | 8500 | 8450 |
| | elastic | value (Mpa) | | | | | | | | |
| | modulus | Evaluation | AA | AA | AA | AA | AA | AA | AA | AA |
| | Impact | Measurement | 6 | 9 | 9 | 6 | 9 | 4.5 | 6 | 6 |
| | strength | value (kJ/m²) | | | | | | | | |
| | | Evaluation | BB | AA | AA | BB | AA | BB | BB | BB |
| | Fluidity | Measurement | 480 | 410 | 370 | 490 | 385 | 415 | 395 | 380 |
| | | value (Pa · s) | | | | | | | | |
| | | Evaluation | BB | BB | BB | BB | BB | BB | BB | BB |
| | Flame | Rank | V-1 | V-1 | V-1 | V-1 | V-1 | V-1 | V-1 | V-1 |
| | retardancy | Evaluation | BB | BB | BB | BB | BB | BB | BB | BB |

| | | Resin composition No. | | | | | |
|---|---|---|---|---|---|---|---|
| | | 9 | 10 | 11 | 12 | 13 | 14 |
| Material | Product name | *1 | *1 | *1 | *1 | *1 | *1 |
| PC | SDPOLYCA301-10 | 72.5 | 72.5 | 72.5 | 72.5 | 72.5 | 72.5 |
| GF | CSF3PE-455 | 20 | 20 | 20 | 20 | 20 | 20 |
| Talc | MICRO ACE P-3 | — | — | — | — | — | — |
| Olefin- | EBA35BA40 | — | — | 7.5 | 7.5 | 7.5 | 7.5 |
| acrylate | EMA29MA03 | 7.5 | — | — | — | — | — |
| (OA) | | | | | | | |
| Olefin- | A-C450 | — | 7.5 | — | — | — | — |
| acrylic | | | | | | | |
| acid (OA) | | | | | | | |
| Mass ratio value (GF/OA) | | 2.7 | 2.7 | 2.7 | 2.7 | 2.7 | 2.7 |
| Lubricant | UNISTAR H476 | — | — | 1.0 | — | — | — |
| | LUNAC S-90V | — | — | — | 1.0 | — | — |
| Flame | PX-200 | — | — | — | | 10 | 20 |
| retardant | | | | | | | |
| Styrenic | H9152 | — | — | — | — | — | — |
| resin | | | | | | | |
| Evaluation | Aspect ratio of GF | 32 | 32 | 32 | 32 | 34 | 35 |

| | | | | | | | |
|---|---|---|---|---|---|---|---|
| Bending | Measurement | 6100 | 6050 | 6050 | 5900 | 6000 | 6000 |
| elastic | value (Mpa) | | | | | | |
| modulus | Evaluation | AA | AA | AA | AA | AA | AA |
| Impact | Measurement | 7.5 | 7.5 | 9 | 8 | 8 | 8 |
| strength | value (kJ/m²) | | | | | | |
| | Evaluation | AA | AA | AA | AA | AA | AA |
| Fluidity | Measurement | 405 | 415 | 320 | 360 | 310 | 220 |
| | value (Pa · s) | | | | | | |
| | Evaluation | BB | BB | AA | BB | AA | AA |
| Flame | Rank | V-1 | V-1 | V-1 | V-1 | V-0 | V-0 |
| retardancy | Evaluation | BB | BB | BB | BB | AA | AA |

*1: Present invention

TABLE II

| | | | Resin composition No. | | | | | | | | | | | |
|---|---|---|---|---|---|---|---|---|---|---|---|---|---|---|
| | | | 15 | 16 | 17 | 18 | 19 | 20 | 21 | 22 | 23 | 24 | 25 | 26 |
| Material | Product name | | *1 | *1 | *1 | *1 | *1 | *1 | *2 | *2 | *2 | *2 | *2 | *2 |
| PC | SDPOLYCA301-10 | | 72.5 | 72.5 | 72.5 | 72.5 | 59 | 65 | 94 | 66 | 80 | 77.5 | 75 | 72.5 |
| GF | CSF3PE-455 | | 20 | 20 | 20 | 20 | 35 | 20 | 0 | 30 | 20 | 20 | 10 | 0 |
| Talc | MICRO ACE P-3 | | — | — | — | — | — | — | — | — | — | — | — | 20 |
| Olefin- | EBA35BA40 | | 7.5 | 7.5 | 7.5 | 7.5 | 6 | 15 | 6 | 4 | 0 | 2.5 | 15 | 7.5 |
| acrylate | EMA29MA03 | | — | — | — | — | — | — | — | — | — | — | — | — |
| (OA) | | | | | | | | | | | | | | |
| Olefin- | A-C450 | | — | — | — | — | — | — | — | — | — | — | — | — |
| acrylic | | | | | | | | | | | | | | |
| acid (OA) | | | | | | | | | | | | | | |
| Mass ratio value (GF/OA) | | | 2.7 | 2.7 | 2.7 | 2.7 | 5.8 | 1.3 | — | 7.5 | — | 8.0 | 0.7 | 2.7 |
| | | | | | | | | | | | | | | (Talc |
| | | | | | | | | | | | | | | ratio) |
| Lubricant | UNISTAR H476 | | — | — | — | 1.0 | — | — | — | — | — | — | — | — |
| | LUNAC S-90V | | — | — | — | — | — | — | — | — | — | — | — | — |
| Flame | PX-200 | | 30 | — | — | 20 | — | — | — | — | — | — | — | — |
| retardant | | | | | | | | | | | | | | |
| Styrenic | H9152 | | — | 10 | 30 | 10 | — | — | — | — | — | — | — | — |
| resin | | | | | | | | | | | | | | |
| Evaluation | Aspect ratio of GF | | 35 | 34 | 35 | 36 | 28 | 33 | — | 29 | 29 | 31 | 35 | — |
| | Bending | Measurement | 5400 | 6000 | 5800 | 5950 | 9200 | 5950 | 2400 | 8900 | 6200 | 6100 | 3600 | 2900 |
| | elastic | value | | | | | | | | | | | | |
| | modulus | (Mpa) | | | | | | | | | | | | |
| | | Evaluation | AA | AA | AA | AA | AA | AA | CC | AA | AA | AA | BB | CC |
| | Impact | Measurement | 6.5 | 8 | 7.5 | 8 | 4 | 5.5 | 15 | 2 | 2 | 2 | 3 | 3.5 |
| | strength | value | | | | | | | | | | | | |
| | | (kJ/m²) | | | | | | | | | | | | |
| | | Evaluation | BB | AA | AA | AA | BB | BB | AA | CC | CC | CC | CC | CC |
| | Fluidity | Measurement | 180 | 310 | 240 | 170 | 415 | 320 | 380 | 510 | 620 | 540 | 315 | 340 |
| | | value | | | | | | | | | | | | |
| | | (Pa · s) | | | | | | | | | | | | |
| | | Evaluation | AA | AA | AA | AA | BB | AA | BB | CC | CC | CC | AA | AA |
| | Flame | Rank | V-0 | V-1 | V-2 | V-0 | V-1 | V-2 | V-1 | V-1 | V-1 | V-1 | V-2 | V-1 |
| | retardancy | Evaluation | AA | BB | BB | AA | BB | BB | BB | BB | BB | BB | BB | BB |

*1: Present invention
*2: Comparative example

From Table I and Table II, it was found that the resin composition having the constitution of the present invention and a molded product using the resin composition of the present invention have characteristics excellent in each of bending elastic modulus, impact strength, fluidity at the time of melting, and flame retardancy compared to the configuration of the comparative examples.

Although the embodiments of the present invention have been described and illustrated in detail, the disclosed embodiments are made for purpose of illustration and example only and not limitation. The scope of the present invention should be interpreted by terms of the appended claims.

What is claimed is:

1. A resin composition comprising a polycarbonate, a glass fiber, and an olefin-acrylate copolymer or an olefin-acrylic acid copolymer,
wherein a mass ratio value (GF/OA) of a content of the glass fiber (GF) to a content of the olefin-acrylate copolymer or the olefin-acrylic acid copolymer (OA) is in the range of 1.0 to 6.0.

2. The resin composition described in claim 1,
wherein the polycarbonate is contained in the range of 60 to 88 mass parts, the glass fiber is contained in the range of 10 to 30 mass parts, and the olefin-acrylate copolymer or the olefin-acrylic acid copolymer is contained in the range of 2 to 10 mass parts.

3. The resin composition described in claim 1,
wherein the olefin in the olefin-acrylate copolymer or the olefin-acrylic acid copolymer is ethylene.

4. The resin composition described in claim 1,
wherein an alkyl group in an alkoxy group in an ester portion of the olefin-acrylate copolymer has 1 to 4 carbon atoms.

5. The resin composition described in claim 4,
wherein the alkyl group has 4 carbon atoms.

6. The resin composition described in claim 1,
wherein an ester lubricant is contained in the range of 0.1 to 3 mass parts per 100 mass parts of the resin composition.

7. The resin composition described in claim 2,
wherein the olefin-acrylate copolymer or the olefin-acrylic acid copolymer is contained in the range of more than 5 mass parts to 10 mass parts or less.

8. The resin composition described in claim 1,
wherein a flame retardant is contained in the range of 10 to 20 mass parts per 100 mass parts of the resin composition.

9. The resin composition described in claim 8,
wherein the flame retardant is a condensed phosphate.

10. The resin composition described in claim 1,
wherein a styrenic resin is contained in the range of 1 to 30 mass parts per 100 mass parts of the resin composition.

11. A method for producing the resin composition described in claim 1 comprising the step of:
kneading the polycarbonate, the glass fiber, and the olefin-acrylate copolymer or the olefin-acrylic acid copolymer with a kneader,
wherein the polycarbonate and the olefin-acrylate copolymer or the olefin-acrylic acid copolymer are introduced from an inlet of a barrel of the kneader, then the glass fiber is added to a latter half of the barrel.

12. A molded product containing the resin composition described in claim 1.
